(19) United States
(12) Patent Application Publication
(10) Pub. No.: US 2003/0140100 A1
(43) Pub. Date: Jul. 24, 2003

(54) System and method for URL response caching and filtering in servlets and application servers

(76) Inventor: Sam Pullara, San Francisco, CA (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/345,667

(22) Filed: Jan. 16, 2003

Related U.S. Application Data
(60) Provisional application No. 60/349,443, filed on Jan. 18, 2002.

(51) Int. Cl. G06F 15/16

(52) U.S. Cl. 709/203; 709/219

(57) ABSTRACT

The invention provides a system and method for providing response caching and filtering for servlets, and particularly for allowing a developer to specify a cache filter for use in caching servlet pages. The cache filter caches on a page level (or included page) instead of at a JSP fragment level. Also, instead of declaring the caching parameters inside the Web document itself, a developer can declare the parameters in the configuration of the web application. The result is that server load is greatly reduced in situations involving many users and frequently changing data. The ability to administer the cache parameters directly instead of at a proxy gives the developer greater latitude in administering and optimizing the performance of their e-commerce application.

### CLAIM OF PRIORITY

This application claims priority from provisional application “SYSTEM AND METHOD FOR URL RESPONSE CACHING AND FILTERING IN SERVLETS AND APPLICATION SERVERS” Application No. 60/349,443 filed Jan. 18, 2002, and which application is incorporated herein by reference.

### CROSS-REFERENCES

This application is related to U.S. Provisional Patent Application No. 60/349,546, entitled “SYSTEM AND METHOD FOR PLUGGABLE URL PATTERN MATCHING FOR SERVLETS AND APPLICATION SERVERS”, filed Jan. 18, 2002 and U.S. Provisional Patent Application No. 60/349,466, entitled “SYSTEM AND METHOD FOR USING VIRTUAL DIRECTORIES TO SERVICE URL REQUESTS IN APPLICATION SERVERS”, filed Jan. 18, 2002, both of which applications are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to application servers and particularly to a system and method for providing response caching and filtering for servlets.

### BACKGROUND

An ever-increasing number of e-commerce providers or e-businesses rely on application server technology as the lifeblood of their business. Application servers form a proven foundation for supporting e-commerce applications, providing the presentation, business and information-access logic, security and management services, and underlying infrastructure required for highly scalable and mission-critical software applications. Increasingly, the demands of today's modern businesses require support for a new breed of Web and wireless applications, helping to meet the needs of increasingly sophisticated customers.

One such application server, WebLogic Server, from BEA Systems, Inc. San Jose, Calif., is based on an implementation of the Java 2 Enterprise Edition (J2EE) specification. WebLogic Server is used as the backbone for many of today's most sophisticated e-business applications, playing an integral role in a tightly integrated, comprehensive infrastructure that delivers commerce, personalization, campaign management, enterprise integration, workflow management, and business-to-business collaboration. From Web and wireless clients to Windows, Unix, and mainframe servers, WebLogic Server manages all of the underlying complexities of a business' e-commerce applications, allowing the organization to focus instead on delivering new and innovative products and services.

A typical application server, including WebLogic Server, supports a variety of clients, including Web browsers, and wireless devices. On the server side, WebLogic Server supports leading Unix, Linux, Windows, and mainframe operating systems. On the back-end, WebLogic Server integrates with relational databases, messages queues, and legacy systems. WebLogic Server provides support for features such as Servlets, Java Server Pages (JSPs), Enterprise JavaBeans (EJBs), Java Messaging Service (JMS), to provide access to standard network protocols, database, and messaging systems. When developing applications, developers can create, assemble, and deploy components that use these services.

In a typical deployment, WebLogic Server also includes a Web server for hosting static content and dynamic J2EE Web applications. J2EE Web applications typically include a collection of HTML/XML pages, Java Server Pages, Servlets, Java classes, applets, images, multimedia files, and other file types. WebLogic Server may also be integrated with other Web servers such as Apache, Microsoft IIS, or Netscape Web servers. Web components usually provide the presentation logic for browser-based or wireless applications, while EJB components encapsulate business objects and processes.

One of the problems with traditional servlet processing, as found in application servers, is the load placed upon the server in serving up data to the servlet for transmission to the user. In a typical e-commerce environment, there may be many hundreds or thousands of users accessing similar or identical data at the same point in time. This places a huge strain on the application or Web server. A typical approach in addressing this problem is to install proxy or caching servers between the user and the application or Web server. The proxy server caches frequently used data and takes much of the strain off the main server. However, the addition of proxy servers adds complexity to an already typically complex network environment, and adds a further layer which must be maintained, administered, and tuned for optimal performance. There is a demand for methods of reducing the strain on the application server that don't add layers of complexity, and that still allow the administrator easy, centralized, control of all aspects of the e-commerce environment.

### SUMMARY

The invention provides a system and method for providing response caching and filtering for servlets. This is a servlet filter which intercepts requests and returns cached responses, and provides caching for static and dynamic content for servlets/jsps. The cache filter caches on a page level (or included page) instead of at a JSP fragment level. Also, instead of declaring the caching parameters inside the Web document itself, a developer can declare the parameters in the configuration of the web application. The result is that server load is greatly reduced in situations involving many users and frequently changing data. The ability to administer the cache parameters directly instead of at a proxy gives the developer greater latitude in administering and optimizing the performance of their e-commerce application.

In accordance with one embodiment, the invention comprises a system for caching and filtering responses in an application server environment, comprising: a web server component, including a web application or servlet for receiving uniform resource indicator requests and passing said requests to the application server; and, a servlet filter for intercepting said uniform resource indicator requests and returning cached responses.

In accordance with another embodiment, the invention comprises a method of caching and filtering responses in an application server environment, comprising the steps of: receiving uniform resource indicator requests at a web server component or servlet for communication to the application server; and, intercepting said uniform resource indicator requests using a servlet filter, and returning cached responses.

### BRIEF DESCRIPTION OF THE DRAWINGS

FIG. 1 shows an illustration of a typical interaction between a user (client) process and a servlet application.

FIG. 2 shows an illustration of a servlet interaction using response caching and filtering in accordance with an embodiment of the invention.

FIG. 3 is a flowchart of a servlet response caching and filtering process in accordance with an embodiment of the invention.

### DETAILED DESCRIPTION

The invention provides a system and method for providing response caching and filtering for servlets. This is a servlet filter which intercepts requests and returns cached responses, and provides caching for static and dynamic content for servlets/jsps. The cache filter caches on a page level (or included page) instead of at a JSP fragment level. Also, instead of declaring the caching parameters inside the Web document itself, a developer can declare the parameters in the configuration of the web application. The result is that server load is greatly reduced in situations that involve many users and frequently changing data. The ability to administer the cache parameters directly at the application server instead of at a proxy server gives the developer greater latitude in administering and optimizing the performance of their e-commerce application. The invention thus addresses the needs especially of those e-commerce customers who maintain high bandwidth sites that must serve up frequently changing content to a large number of users.

The cache filter is particularly useful for caching dynamic content, such as JSP's and servlets. Upon startup, the administrator can specify a set of cache parameters that define how the cache operates. The administrator can also flush a particular cache as necessary to free up space. The content of a dynamic content jsp or servlet may change for each user request (for example a news item on a Web site may change slightly from an early version to a later version) but sometimes the e-commerce provider doesn't want or need to always refresh the content to the latest version. Instead, the administrator can define their system to maybe only change once per particular event, and after that event occurs to flush the cache.

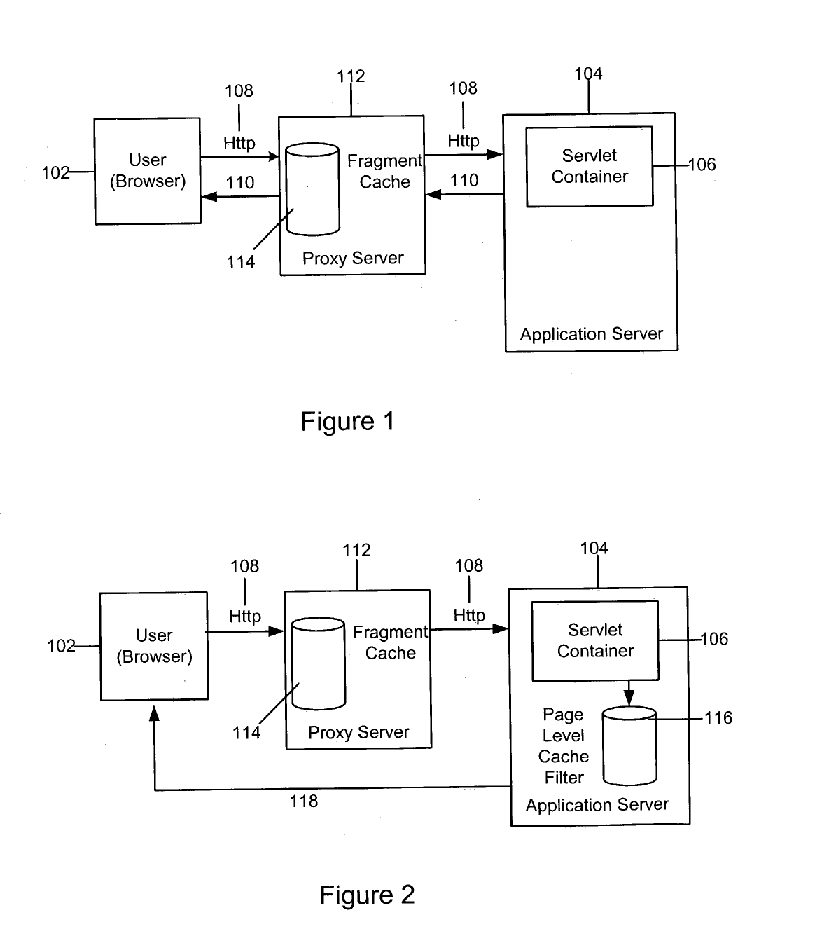

FIG. 1 shows an illustration of a typical interaction between a user process or browser and a servlet application in a system that does not use a servlet cache filter. As shown in FIG. 1, a user 102, typically operating a browser or WAP device, accesses an application server 104 including a web servlet or servlet container 106 with an http request 108 to receive data content. A typical high capacity e-commerce site uses proxy servers 112 to cache frequently accessed data requested by the user. Usually only page fragments (such as GIF images, etc.) are cached in a page fragment cache 114. Although only a single proxy server and fragment cache are shown in FIG. 1, a typical setup would include many proxy servers, each with one or more associated caches. As the number of proxy servers increases, the administrative burden and the technical difficulties associated with the system also increases.

FIG. 2 shows an illustration of a servlet interaction using response caching and filtering in accordance with an embodiment of the invention. As before, a user 102 operating a browser accesses an application server 104 and servlet container 106 with an http request 108. While a proxy server may again be used to cache some data, the invention also includes a server side response cache filter to assist in the caching process. The response cache takes the load off the application server, and doesn't require any processing on the server side.

Unlike a simple cache tag feature, the cache filter in accordance with the present invention also includes support for pages that were not included from another page. For example, the cache filter automatically caches the response headers Content-Type and Last-Modified fields. When the system receives an http request that results in a cached page it compares the If-Modified-Since request header to the Last-Modified response header (like the FileServlet does) to determine whether it needs to actually serve the content or if it can instead send an 302 SC_NOT_MODIFED status with an empty content instead. This filtering can save a great deal of bandwidth. The following filter shows an example of registering a cache filter to cache all the HTML pages in a web application:

<filter>
<filter-name>HTML</filter-name>
<filter-class>weblogic.cache.filter.CacheFilter</filter-class>
</filter>
<filter-mapping>
<filter-name>HTML</filter-name>
<url-pattern>* .html</url-pattern>
</filter-mapping>

In accordance with one embodiment of the invention, the cache system uses soft references for storing the cache. In this embodiment the garbage collector might or might not reclaim the cache depending on how recently the cache was created or accessed. To make sure that the cache is updated when the corresponding web pages are, an administrator can add a timeout to the filter. Using the init-params a developer can set many of the same parameters that can be set for the cache tag:

<filter>
<filter-name>HTML</filter-name>
<filter-class>weblogic.cache.filter.CacheFilter</filter-class>
<init-param>
<param-name>timeout</param-name>
<param-value>1m</param-value>
</init-param>
</filter>

This ensures that the FileServlet is used every minute to ensure that the content is completely up to date. The cache will be checked for expiration when it is accessed. If the data has expired the old cache will be cleared and a new version will be fetched. The following list illustrates some of the supported initialization parameters supported by the cache filter:

Name—the name of the cache. The name defaults to the request URI for compatibility with *.extension URL patterns. A system administrator can flush a particular cache by specifying it's name from a jsp page as following: <wl:cache name=“HTML” flush=“true”/>

Timeout—the amount of time since the last cache update that the filter will waits until trying to update the content in the cache again. The default unit is seconds but the timeout can also be specified in units of ms (milliseconds), s (seconds), m (minutes), h (hours), or d (days). An administrator can define the timeout for a particular cache.

Scope—the scope of the cache can be any one of request, session, application, or cluster. Request scope is useful for looping constructs in the page. The scope defaults to application.

Key—specifies that the cache is further specified not only by the name but also by values of various entries in scopes. These are specified just like the keys in the CacheTag.

Vars—variables calculated by the page that is being cached. Typically the vars are used with servlets that retrieve information from a database in response to some sort of input parameters.

Size—the size limits the number of different unique key values cached, and defaults to a value of infinity.

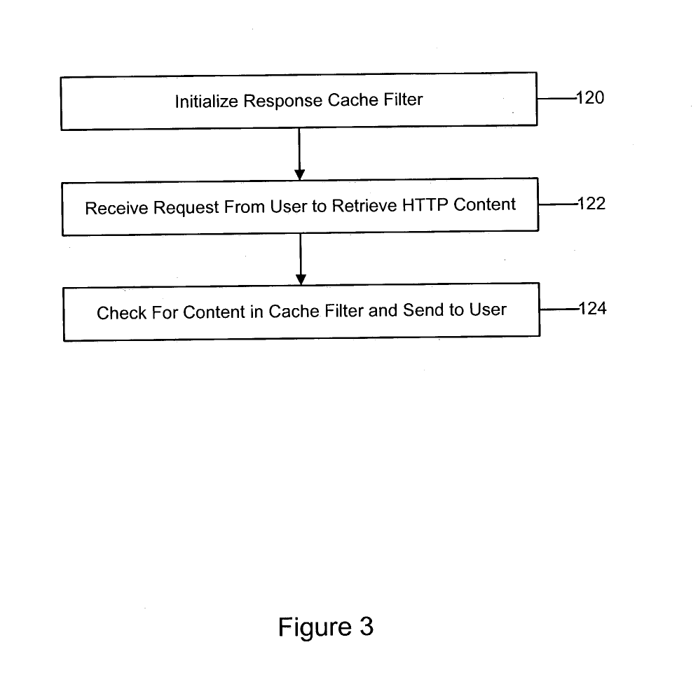

FIG. 3 shows a flowchart of a servlet response caching and filtering process in accordance with an embodiment of the invention. As shown in FIG. 3, the process begins in step 120 by initializing the response cache filter. In step 122, the system receives a request from a user to retrieve data content. If the page requested is in the cache filter the cached page is communicated, in step 124 to the user.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that the response cache can be used to cache dynamic data other than servlets. In addition, the CacheFilter can also be used to cache static content (for example images and html files). The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for caching and filtering responses in an application server environment, comprising:
a web server component, including a web application or servlet for receiving uniform resource indicator requests and passing said requests to the application server; and,
a servlet filter for intercepting said uniform resource indicator requests and returning cached responses.

2. The system of claim 1 wherein said servlet filter provides caching for both static and dynamic content for web applications, servlets and jsp's.

3. The system of claim 1 wherein said cache filter caches on a page level.

4. The system of claim 1 wherein the caching parameters are declared inside a Web document accessed as part of the uniform resource indicator request.

5. The system of claim 1 wherein the caching parameters are declared in the configuration of the web application or servlet.

6. The system of claim 1 wherein the set of cache parameters that define how the cache operates can be defined by an administrator.

7. The system of claim 1 wherein the cache filter includes support for pages that were not included from another page by automatically caching the response headers Content-Type and Last-Modified fields.

8. The system of claim 7 wherein the system compares the If-Modified-Since request header to the Last-Modified response header to determine whether it needs to actually serve the content in response to the request.

9. The system of claim 1 wherein a cache filter can be registered to cache all of the HTML pages in a web application matching a particular uniform resource indicator pattern.

10 A method of caching and filtering responses in an application server environment, comprising the steps of:
receiving uniform resource indicator requests at a web server component or servlet for communication to the application server; and,
intercepting said uniform resource indicator requests using a servlet filter, and returning cached responses.

11. The method of claim 10 wherein said servlet filter provides caching for both static and dynamic content for web applications, servlets and jsp's.

12. The method of claim 10 wherein said cache filter caches on a page level.

13. The method of claim 10 wherein the caching parameters are declared inside a Web document accessed as part of the uniform resource indicator request.

14. The method of claim 10 wherein the caching parameters are declared in the configuration of the web application or servlet.

15. The method of claim 10 wherein the set of cache parameters that define how the cache operates can be defined by an administrator.

16. The method of claim 10 wherein the cache filter includes support for pages that were not included from another page by automatically caching the response headers Content-Type and Last-Modified fields.

17. The method of claim 16 further comprising the step of:
comparing the If-Modified-Since request header to the Last-Modified response header to determine whether it needs to actually serve the content in response to the request.

18. The method of claim 10 wherein a cache filter can be registered to cache all of the HTML pages in a web application matching a particular uniform resource indicator pattern.
